(19) United States
(12) Patent Application Publication
(10) Pub. No.: US 2025/0019842 A1
(43) Pub. Date: Jan. 16, 2025

(54) STRUCTURAL DESIGN OF AN ELECTROCHEMICAL CELL

(71) Applicant: Evonik Operations GmbH, Essen (DE)

(72) Inventor: Artjom Maljusch, Bochum (DE)

(21) Appl. No.: 18/711,089

(22) PCT Filed: Nov. 9, 2022
(86) PCT No.: PCT/EP2022/081185

§ 371 Date: May 16, 2024

(30) Foreign Application Priority Data
Nov. 16, 2021 (EP) 21208566.6

(51) Int. Cl. C25B 11/056; C25B 1/04; C25B 11/031; C25B 11/061

(52) U.S. Cl. CPC C25B 11/056; C25B 1/04; C25B 11/031; C25B 11/061

(57) ABSTRACT

The present invention relates to an electrochemical cell (0) comprising an anode (1), a cathode (2) and an anion-conducting membrane (3) located between the anode (1) and the cathode (2). The invention also relates to the use of the cell (0) in a method for preparing hydrogen (H₂) and oxygen (O₂) by electrochemically splitting water (H₂O). Moreover, the invention relates to an electrolyser (6, 8) comprising a multiplicity of the cells (0), and to a method for producing the electrolyser (6, 8). The aim of the invention is to provide an electrochemical cell (0) by means of which anion-exchange-membrane-based water splitting can be carried out on an industrial scale. The aim is also for the cell to be inexpensive in terms of production and to allow for the energy-efficient preparation of hydrogen and oxygen. The aim is achieved in that at least part of the anode is in the form of a first textile fabric comprising catalytically active textile line structures, and in that the first textile fabric directly contacts the membrane.

The present invention relates to an electrochemical cell comprising an anode, a cathode, and an anion-conducting membrane disposed between anode and cathode. It also relates to the use of the electrochemical cell in a process for producing hydrogen and oxygen by electrochemical splitting of water. The invention additionally relates to an electrolyser having a multitude of cells, and to a process for producing the electrolyser.

Electrochemical cells are used for performance of electrochemical processes. There is a multitude of electrochemical processes having very different objectives. An important electrochemical process is the breakdown of chemical compounds. This process is called electrolysis.

The industrial implementation of an electrochemical cell for performance of electrolyses is called an electrolyser. An electrolyser usually contains a multitude of interconnected electrochemical cells.

An electrochemical cell always has two electrodes: a cathode and an anode. The cell is usually divided into two compartments by an electrically insulating separator. The anode is present in the first, “anodic” compartment, and the cathode in the second, “cathodic” compartment. The two electrodes or compartments are electrically separated from one another by the separator. The electrochemical cell is filled or permeated with water or an aqueous basic electrolyte.

An important electrochemical process is the production of hydrogen and oxygen by electrochemical splitting of water. One variant of water electrolysis is characterized by the use of an anion-conducting membrane (anion exchange membrane, AEM) as separator. It is commonly referred to as AEM water electrolysis (AEMWE). Since the reaction is effected in an alkaline medium, AEM water electrolysis is often also called alkaline membrane water electrolysis.

In the case of AEM water electrolysis, an electrochemical cell is filled with water or with a basic water-based electrolyte, and a voltage is applied between anode and cathode. On the cathode side, the water is split into hydrogen (H₂) and hydroxide ions (OH⁻) (Equation 1). The membrane transports the hydroxide ions onto the anode side, where they are oxidized to oxygen (O₂) (Equation 2). In this way, oxygen is formed on the anode side, while the hydrogen is formed on the cathode side. Consequently, the anode side is also called oxygen side, while the cathode side is also called hydrogen side.

2H₂O+2e⁻→H₂+2OH⁻ (1)

2OH⁻→½O₂+H₂O+2e⁻ (2)

In order to enable the effect described, the membrane must conduct the hydroxide ions between anode and cathode. At the same time, it must be electrically insulating in order that there is no electrical short circuit between anode and cathode. Finally, the anion-conducting membrane must be gas-tight if possible, in order that there is no backmixing of the gases formed. Moreover, the anion-conducting membrane must withstand the alkaline conditions that exist in AEM water electrolysis. These properties are satisfied by specific anion-conducting polymers (also called anion-conducting ionomers).

In order to accelerate the reaction, catalytically active substances (also called electrocatalysers) are installed both on the cathode side and on the anode side. This is accomplished by introducing catalytically active layers or catalytically active coatings. These may be present on a substrate material specially introduced into the cell for the purpose or on a porous transport layer (catalyst-coated substrate, CCS), or else the membrane may be directly coated with catalytically active material (catalyst-coated membrane, CCM).

In AEM water electrolysis, a flow of water or basic electrolyte through the cell and a gas/electrolyte flow out of the cell must be implemented in order to supply fresh water for electrolysis and to remove hydrogen and oxygen formed, or water or basic electrolyte enriched therewith, again. This is generally enabled by a porous transport layer (PTL) which firstly closely adjoins the catalytically active layer in order to enable good electrical contact; it is secondly electrically conductive and has sufficient porosity for outward transport of gas and supply of water and electrolyte. In order to improve the transport of the water or basic electrolyte through the cell, a specific channel structure (called the flow field, FF) is incorporated into the cell. This structure is to have electrical contact with the porous transport layer, is to be electrically conductive and is to establish electrical contact with an end plate or with a bipolar plate (BPP). The bipolar plates electrically connect two adjacent cells. A specific channel structure is often incorporated directly into the bipolar plate, for example by mechanical deformation. For efficient water electrolysis, it is particularly important that the contact resistances at the contact surfaces (i) of catalytically active layer with the porous transport layer, (ii) of porous transport layer with the flow field, and (iii) of the flow field with bipolar plate are kept to a minimum and do not rise during the operation of the electrolyser as a result of possible oxidation or passivation of the contact surfaces. Otherwise, the elevated contact resistances will lead to higher cell voltage and lower efficiency, and to higher energy consumption.

An excellent overview of the construction and materials of the electrochemical cells currently in use in AEM water electrolysis is given by:
Miller, Hamish Andrew et al: Green hydrogen from anion exchange membrane water electrolysis: a review of recent developments in critical materials and operating conditions. Sustainable Energy Fuels, 2020, 4, 2114 DOI: 10.1039/c9se01240k.

The general aims of the development of electrolysers for water electrolysis are the improvement of the efficiency of the process and the reduction of manufacturing costs for the electrolyser.

The idea recently arose of using textile structures as electrodes in alkaline water electrolysis. For instance, the research group of Zhu Silu coated a felt made of stainless steel fibres with nickel-iron hydroxide and used it as anode and cathode in a water electrolysis:
Zhu Silu et al.: Fast Electrodeposited Nickle-Iron Hydroxide Nanosheets on Sintered Stainless Steel Felt as Bifunctional Electrocatalyst for Overall Water Splitting. ACS Sustainable Chem. Eng. 2020, 8, 9885-9895 DOI: 10.1021/acssuschemeng.0c03017.

The advantage of this course of action is the high catalytically active surface area of the electrodes which is obtained owing to nanostructuring. The extent to which such a material can be incorporated into an electrochemical cell is left unclear by Zhu et al.: For instance, the electrochemical cell presented in the article does not have any separator or membrane at all that separates the gases formed. Consequently, backmixing of the hydrogen and oxygen gases formed at anode and cathode is to be expected here, which can cause a hydrogen/oxygen gas explosion. It is admittedly the case that such a cell can be operated in the laboratory for research purposes, but it is unsuitable for industrial production of hydrogen.

It is an object of the present invention to specify an electrochemical cell with which an AEM water electrolysis can be conducted on an industrial scale. The cell is to incur low production costs and enable energy-efficient production of hydrogen and oxygen.

This object is achieved by an electrochemical cell according to Claim 1.

The invention therefore provides an electrochemical cell comprising an anode, a cathode and an anion-conducting membrane disposed between anode and cathode, in which the anode is at least partly executed as a first textile fabric comprising catalytically active linear textile structures, and in which the first textile fabric is in direct contact with the membrane.

A significant finding of the present invention is that textile structures are suitable not just as electrode and electrocatalyst, but can simultaneously also assume the function of a porous transport layer and of a flow field for the electrolyte and/or the gases formed; textile fabrics are porous in principle, since cavities exist between the individual linear structures. The water or basic electrolyte can penetrate into these cavities and hence come into contact with the electrocatalyst. The gas formed can likewise escape through the cavities. In this way, the textile fulfils not just electrochemical functions but also fluidic functions. By virtue of their fluid-conducting properties, the textile electrode may be contacted directly with the membrane. This means that the textile fabric directly and two-dimensionally adjoins the membrane. There is thus direct mechanical contact between the membrane and the textile fabric, preferably over the entire area of membrane and electrode. At the same time, there can be no question of contact in an electrical sense because the membrane is not electrically conductive. By virtue of the fluid-conducting properties of the textile, the electrochemical cell according to the invention can work without an additional porous transport layer and without an additional flow field. This reduces the electrical internal resistance of the cell since there are no contact resistances between the individual components that are typically used.

An additional advantage of the electrochemical cell according to the invention is that there is no absolute need for an ionomer (also often referred to as binder) for immobilization of electrocatalysts on the substrate or electrode (CCS) or directly on the membrane (CCM) on the anode side of the electrolyser. Oxygen formed during the electrolysis is very active and can chemically attack (oxidize) the ionomer, which leads to impairment of the mechanical and ion-conducting properties of the ionomer and can also cause the detachment of the electrocatalyst. This then leads to an increase in the cell voltage required and to elevated energy consumption. As a result, the proposed structure of an electrochemical cell reduces the manufacturing costs thereof and, on account of the low electrical resistances, enables an energy-efficient process.

On account of the advantages of the textile structure, the anode is preferably executed completely in the form of a textile fabric. This means that a textile fabric is used as anode. However, it is also conceivable to use an anode that is only partly in the form of a textile fabric and otherwise consists of non-textile material. For instance, it would also be possible to secure the textile fabric on a solid panel or on a flat or formed sheet, or else on a non-textile material, for instance an expanded metal, a metal mesh.

The term “textile fabric” is used here as is customary in textile technology. It refers to essentially two-dimensional textile structures irrespective of their binding, for example weaves, braids, interlooped materials, meshes, knits, nonwovens, wadding and felts. Textile fabrics with a multilayer structure in the context of the invention are regarded as a two-dimensional textile structure. The fact that a textile fabric has a certain thickness does not mean that it is not two-dimensional.

Textile fabrics are formed from linear textile structures. Linear textile structures in this connection are essentially one-dimensional textile structures, for example fibres, filaments, threads or yarn. The fibres may be continuous or finite.

It is essential that the linear textile structures are catalytically active. This means that they are manufactured at least partly from a material that accelerates the electrochemical reaction conducted with the cell. The catalytically active material must be present at least on the surface of the linear textile structures.

The catalytically active material is preferably an element selected from the group consisting of Au, Pt, Pd, Ir, Rh, Ru, Ag, Ni, Co, Cu, Fe, Mn, Mo. The element may be used in elemental form (for example in the form of a homogeneous catalytically active coating or of catalytically active particles) or in the form of an alloy or of a compound, for example of an oxide, mixed oxide, hydroxide, mixed hydroxide, spinel or perovskite. All these substances are capable of accelerating electrochemical reactions such as, in particular, alkaline water electrolysis.

In a preferred embodiment of the invention, the catalytically active linear structures consist of a nickel-containing material. Consequently, the undiluted material is catalytically active. This has the advantage that, in the case of erosion of the surface, there is no disappearance of catalytically active material, which is always present. This embodiment is particularly robust. The catalytically active undiluted material is also available inexpensively, namely as nickel or as nickel-containing alloys such as, in particular, Hastelloy, Chronin, Monel, Inconel, Incoloy, Invar, Kovar. It is also possible to use steel containing nickel, stainless steel containing nickel, steels of steel types AISI 301, AISI 301L, AISI 302, AISI 304, AISI 304L, AISI 310, AIS1310L, AIS1316, AISI 316L, AISI 317, AISI 317L, AISI 321. This use of these standard materials as catalytically active material for the first textile fabric makes it unnecessary to coat the fibres with other catalysts.

In a second embodiment of the invention, the linear textile structures comprise a substrate that has been provided with a catalytically active coating on its surface, where the catalytically active coating contains at least one element selected from the group consisting of Au, Pt, Ir, Ru, Rh, Pd, Ag, Ni, Co, Cu, Fe, Mn, Mo, or a compound, for example an oxide, mixed oxide, hydroxide, mixed hydroxide, spinel or perovskite, of the selected element. The substrate in that case need not itself be catalytically active. The linear textile structures gain their catalytic activity by virtue of their coating. For example, it is possible to use inexpensive carbon fibres that are chemically inert and long-lived. The catalytic activity is implemented by the coating. It is of course also possible to coat even catalytically active substrates with catalytically active substance, in order to achieve a particularly high activity. The following substrate materials in particular are useful: nickel; nickel-containing alloys such as Hastelloy, Chronin, Monel, Inconel, Incoloy, Invar, Kovar; steel containing nickel, stainless steel containing nickel, steel types AISI 301, AISI 301L, AISI 302, AISI 304, AISI 304L, AISI 310, AIS1310L, AIS1316, AISI 316L, AISI 317, AISI 317L, AISI 321; titanium, carbon.

The substrate is preferably coated with the catalytically active material without the use of polymer binders. The catalytically active coating is then free of polymers. This has the advantage that the coating is more chemically stable and cannot become detached on degradation of the polymer. Coating without polymer is possible by, for example, electrodeposition of the catalytically active material on the substrate or by sputtering or vapour deposition. More particularly, the coating is free of ionomers, i.e. ion-conducting polymers.

Since the textiles described here are also suitable as cathode, a preferred development of the invention envisages that not just the anode but also the cathode is at least partly executed as a textile fabric. In order to distinguish between fabric utilized as cathode and as anode, first textile fabric is used here for the material utilized as anode, while the second textile fabric is used for the material utilized as cathode.

On the cathode side, integration of the catalytic activity into the textile material is not absolutely necessary. Nevertheless, it is preferable when catalytically active material is used for the second textile fabric as well. The same material as on the anode side is suitable here. In the simplest case, the same material is utilized both on the anode side and on the cathode side. However, this need not necessarily be the case. Therefore, distinction between first and second textile fabric is appropriate. Preferably, the cathode is executed entirely as a textile fabric.

The second textile fabric, as well as the electrochemical function as cathode, also fulfils the function of a porous transport layer and of a flow field for the water or for the basic electrolyte and/or the gases formed.

An electrochemical cell having two textile electrodes can be structured in two variants:

In a first variant, the second textile fabric (cathode, hydrogen side) is in direct contact with the membrane. If the membrane in that case is itself not coated with any catalytically active material (electrocatalyst), this requires that the catalytically active substances have been applied to the linear structures of the second textile fabric or that the material of the second textile fabric itself is catalytically active.

In a second variant, a catalytically active layer (electrocatalyst) is disposed between the second textile fabric (cathode, hydrogen side) and the membrane. The linear textile structures from which the second textile fabric is constructed need then not necessarily be catalytically active or coated with catalytically active substances. The linear structures of the second textile fabric in this case must merely be electrically conductive in order to enable electrical contact between catalytically active layer (electrocatalyst) and flow field or bipolar plate (for example textile fabric made of carbon fibres and/or carbon filaments). This construction is advantageous when the intention is to use an electrocatalyst that cannot be integrated into the fibres or from which it is not possible to produce fibres and/or filaments or which cannot be applied with long-term stability to the fibres and/or filaments or which has a higher catalytic activity than the fibre material or filament material itself.

In a particularly preferred embodiment of the invention, the first textile fabric and/or the second textile fabric is a felt or a nonwoven. The linear textile structures from which felts or nonwovens are constructed are fibres. In a felt and in a nonwoven, the fibres are laid in an unordered multidirectional manner, and adjacent fibres are joined to one another via transverse bonds. The transverse bonding of the metal fibres is preferably effected by calendering. Thermoplastic material may also be fused together.

The nonwoven or felt preferably comprises at least two types of catalytically active linear textile structures: a first type having higher catalytic activity and a second type having lower catalytic activity. The two relative terms “lower” and “higher” relate to the catalytic activity of the respective other catalytically active linear textile structures. An absolute statement of catalytic activity is not useful here; all that matters is that the catalytic activity of one kind is greater than that of the other kind. The two types of catalytically active linear structures are distributed differently within the textile fabric. One type is concentrated in a first region, the other type in a second region. The region with the more catalytically active linear structures will then be disposed closer to the membrane than the region with the less catalytically active linear structures. The effect of this is that the catalytic activity of the textile structure in the boundary region to the membrane is elevated compared to the side of the textile remote from the membrane. It is thus possible to use a particularly active material close to the membrane, said material being correspondingly more expensive. The catalytically less active and inexpensive material is used where the electrochemical reaction is proceeding only to a lesser degree, namely in the region of the textile fabric remote from the membrane. Advantageously, the catalytically less active type of linear textile structures is made from particularly oxidation- or corrosion-resistant material. Particularly high corrosion resistance of the cell components used is particularly important for efficient water electrolysis since possible oxidation or passivation of the contact surfaces between the individual cell components in the course of operation of the electrolyser will lead to an increase in contact resistances. This will then lead to higher cell voltage and lower efficiency, and to higher energy consumption. For the same reason, it is particularly advantageous when the non-textile material, for example an expanded metal, a metal mesh on which a nonwoven or felt may be secured, also consists of a particularly oxidation- or corrosion-resistant material.

The felt preferably consists entirely of fibres of catalytically active material. When the felt also comprises catalytically inactive linear structures, this proportion should be small; it should preferably be less than 50% by weight and more preferably less than 10% by weight, based on the total weight of the felt.

The felt is preferably formed from at least two felt layers, in which case the two felt layers consist of fibres of different thickness. The felt layer composed of finer fibres should then be disposed closer to the membrane than the felt layer composed of thicker fibres. The effect of this is that the electrode consists of finer fibres toward the membrane. This is advisable because a greater density of the catalytically active sites is required close to the membrane, while greater permeability for water or electrolyte and gases formed is required away from the membrane. It is also possible to form the felt from more than two layers, for example from three or four or five or six layers. The thickness of the fibres and/or filaments then decreases stepwise from layer to layer in membrane direction. Correspondingly, the spatial concentration of the catalytically active sites increases in membrane direction. It is important that the felt layers have sufficient porosity E for the transport of the water or the basic electrolyte or of the gases formed, which is preferably between 50% and 90%. Porosity E is determined by equation (3).

$$ε = ( {ρ}_{solid} - {ρ}_{porous body} ) / {{ρ}_{solid}}^{*} 100 \% \qquad ( 3 )$$

In equation (3), ρ_{solid} represents the density of the solid nonporous material and ρ_{porous body} the density of the porous body.

The porosity ε of the felt determined by this method is preferably from 50% to 90% in the region of contact with the membrane and from 50% to 90% in the region remote from the membrane.

The diameter of the fibres and/or filaments of the felt can be determined by means of scanning electron microscopy (SEM).

The diameter of the fibres of the felt determined by this method is preferably from 1 μm to 25 μm in the region of contact with the membrane and from 5 μm to 1000 μm in the region remote from the membrane.

Felt layers may be joined to one another via transverse bonds, such that the felt can be handled as one component in spite of the layer structure. This facilitates the assembly of the cell.

Particularly advantageously, it is possible to use filter felts made of stainless steel of the SAE 316L type as electrode material. Such products are very widely and inexpensively commercially available from various suppliers. Since this steel type contains nickel, it is intrinsically catalytically active as undiluted material.

As already mentioned above, the variant of the invention with the catalyst layer between cathode and membrane has the advantage that it can contain electrocatalysts that cannot be applied readily to a textile substrate. Thus, the catalyst layer may contain catalytically active particles or coating or compounds (electrocatalysts) comprising elements such as Au, Pt, Ir, Ru, Rh, Pd, Ag, C, Ni, Mn, Mo, Co, Cu, Fe.

It is particularly advantageous when the catalytically active particles of the electrocatalyst are embedded in an anion-conducting polymer. Ion-conducting polymers are called ionomer. The embedding of the catalytically active particles into the anion-conducting ionomer enables direct passage of hydroxide ions formed during the reduction of the water at the cathode into the membrane after the reaction. It is very particularly preferable when the ion-conducting polymer has very good adhesion to the surface of the membrane and very good conductivity of the hydroxide ions. In that case, there is particularly effective integration of the catalyst particles with the membrane and particularly good anion-conductive binding of the catalyst particles to the membrane.

By contrast with the known CCM design (the membrane is coated with electrocatalysts on both sides), however, the membrane of the structure of the invention is preferably provided with a catalyst layer exclusively on the cathodic, hydrogen-producing side. It does not have any catalyst layer on the anodic, oxygen-producing side; the electrocatalyst is integrated into the anode material on the oxygen side. Consequently, the variant with a catalyst layer exclusively on the cathode side may be regarded as a “half-CCM cell”.

The material from which the anion-conducting membrane is formed is also an ionomer. In principle, all anion-conducting ionomers can be incorporated into the electrochemical cell according to the invention and the function therein of separation-active membrane material and/or are used for immobilization of catalytically active particles. Preferably, the same anion-conducting polymer is used as separation-active membrane material and for immobilization of the catalytically active particles on the membrane, because particularly good anion-conductive binding of the catalytically active sites to the membrane is then assured. In this case, the same anion-conducting polymer is present both in the catalyst layer and in the membrane.

Particular preference is given to using an anion-conducting polymer that obeys the structural formula (I) or (II) or (III).

The common advantage of the ionomers of structural formula (I), (II) or (III) is their good ionic conductivity, high swelling resistance in an alkaline medium, and low synthesis costs.

The ionomers of the structural formula (I) or (II) or (III) may be used either for production of the membrane or as binder for immobilization of electrocatalysts in the catalytically active layer or on inactive linear textile structures.

The anion-conducting polymer of structural formula (I) is defined as follows:

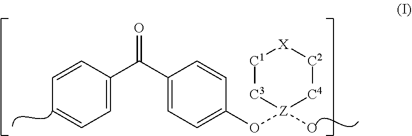

in which X is a structural element comprising a positively charged nitrogen atom which is bonded to C¹ and C² and which is bonded to one or two hydrocarbyl radicals via two bonds, comprising 1 to 12, preferably 1 to 6, more preferably 1 or 5, carbon atoms, and in which Z is a structural element comprising a carbon atom which is bonded to C³ and C⁴ and which comprises at least one aromatic six-membered ring bonded directly to one of the oxygen atoms, where the aromatic six-membered rings may be substituted by one or more halogen radicals and/or one or more C₁- to C₄-alkyl radicals.

The preparation of ionomers of structural formula (I) is described in WO 2021/013694 A1.

The anion-conducting polymer of structural formula (II) is defined as follows:

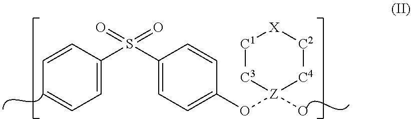

in which X is a structural element comprising a positively charged nitrogen atom which is bonded to C¹ and C² and which is bonded to one or two hydrocarbyl radicals via two bonds, comprising 1 to 12, preferably 1 to 6, more preferably 1 or 5, carbon atoms, and in which Z is a structural element comprising a carbon atom which is bonded to C³ and C⁴ and which comprises at least one aromatic six-membered ring bonded directly to one of the oxygen atoms, where the aromatic six-membered ring in positions 3 and 5 may be substituted by the same or different C₁- to C₄-alkyl radicals, especially by a methyl, isopropyl or tert-butyl group, preference being given to the methyl group.

The preparation of ionomers of structural formula (II) is described in European application 21152487.1 that was still unpublished at the filing date of this application.

The anion-conducting polymer of structural formula (III) is defined as follows:

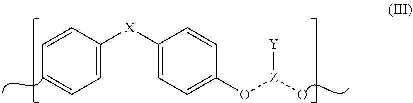

in which X is a ketone or sulfone group;
in which Z is a structural element comprising at least one tertiary carbon atom and at least one aromatic six-membered ring, where the aromatic six-membered ring is directly bonded to one of the two oxygen atoms;
in which Y is a structural element comprising at least one nitrogen atom having positive charge, where this nitrogen atom is bonded to the structural element Z.

The preparation of ionomers of structural formula (III) is described in European application 21162711.2 that was still unpublished at the filing date of this application.

Irrespective of whether the electrochemical cell is equipped with one or two textile fabrics (electrodes), it is advantageous when the first textile fabric and/or the second textile fabric is contacted with a bipolar plate on their side remote from the membrane. What is meant by “contacted” here is at least in an electrical sense, and preferably both in an electrical and mechanical sense because a bipolar plate is electrically conductive. The contacting is preferably effected over the full area. More preferably, direct electrical and mechanical contacting is envisaged, in which no further material is incorporated into the cell between electrode and bipolar plate. In this way, the cell becomes particularly compact and cost-efficient. The fluid-conducting functions of the textile fabric are then exploited optimally. If required, a fluid conductor or a transport layer of non-textile material may be incorporated between the textile fabric and the bipolar plate, for instance an expanded metal or a metal mesh. The fluid conductor or transport layer in that case must be electrically conductive in order to assure electrical contact between the textile material and the bipolar plate. In this arrangement, however, there is then no direct mechanical contact between the textile fabric and the bipolar plate, but rather merely direct mechanical contact via the non-textile fluid conductor or the transport layer. The bipolar plate can be used to create electrical contact with an adjacent electrochemical cell. Thus, a space-saving series connection of multiple electrochemical cells in a stack is possible; see below.

The bipolar plate preferably consists of one of the following materials: nickel; nickel-containing alloys, such as Hastelloy, Chronin, Monel, Inconel, Incoloy, Invar, Kovar; steel containing nickel, stainless steel containing nickel, steels of the AISI 301, AISI 301L, AISI 302, AISI 304, AISI 304L, AISI 310, AIS1310L, AIS1316, AISI 316L, AISI 317, AISI 317L, AISI 321 type; nickel-plated steel, nickel-plated stainless steel, nickel-plated titanium, nickel-plated brass, carbon.

The electrochemical cell presented here is optimized for use in an alkaline membrane water electrolysis (AEM-based water electrolysis). The invention therefore provides for the production of hydrogen and oxygen by electrochemical splitting of water, having the following process steps:
providing at least one electrochemical cell of the invention;
providing water or an aqueous electrolyte having a pH of 7 to 14;
providing an electrical voltage source;
soaking and permeating at least one textile fabric with water or with the aqueous electrolyte;
contacting anode and cathode with an electrical voltage drawn from the electrical voltage source;
drawing off oxygen from the first textile fabric;
drawing off hydrogen from the second textile fabric.

The electrolyte used here contains the water to be electrolysed. By addition of one or more compounds, for example NaOH, KOH, Na₂CO₃, K₂CO₃, NaHCO₃, KHCO₃, to the water, it is possible to adjust the pH of the resulting electrolyte (according to the compound) within the range from pH 7 to pH 14.

The process can be conducted in two variants: wet and semi-dry. In the wet variant, the two compartments are charged with water or the electrolyte; in other words, the first and second textile fabrics are soaked with water or with electrolyte and permeated with water or with electrolyte during the electrolysis. In the semi-dry procedure, just one of the two compartments is charged with the water or the electrolyte and only one of the two textile fabrics is permeated during the electrolysis, either on the anode side (the first textile fabric, semi-dry case 1) or the cathode side (the second textile fabric, semi-dry case 2).

In the wet variant, the two compartments on either side of the membrane are soaked with water or with the aqueous basic electrolyte, and the water or the basic electrolyte permeates through the two compartments during the electrolysis. The hydrogen accumulates in the water or in the aqueous electrolyte on the cathode side, the oxygen on the anode side. If the gas does not bubble out of the electrolyte of its own accord, the electrolyte is drawn in from both compartments and is freed of the desired gas. In general, the amount of gas formed is sufficient that only gas formed at the start of the electrolysis will dissolve in the water or in the basic electrolyte, but electrolyte is saturated very quickly with gases and then the gas bubbles escape from the electrolyte of their own accord (a gas-electrolyte mixture is formed). For instance, in the wet variant, in general, a gas-liquid separation must be conducted. The gas-liquid separation must be conducted in separate apparatuses in order to prevent the mixing of the gases produced (hydrogen and oxygen).

Specifically, a wet process variant has the following steps:
a) providing at least one electrochemical cell comprising an anode, a cathode and an anion-conducting membrane disposed between anode and cathode, in which the anode is at least partly executed as a first textile fabric comprising catalytically active linear textile structures, and in which the first textile fabric is in direct contact with the membrane;
b) providing water or an aqueous electrolyte having a pH of 7 to 14;
c) providing an electrical voltage source;
d) soaking and permeating the first textile fabric with water or with the electrolyte;
e) soaking and permeating the second textile fabric with water or with the electrolyte;
f) passing water or electrolyte through the first textile fabric;
g) passing water or electrolyte through the second textile fabric;
h) contacting anode and cathode with an electrical voltage drawn from the electrical voltage source;
i) drawing off oxygen from the first textile fabric and/or from the water or from the electrolyte with oxygen enriched therein from the first textile fabric;
j) drawing off hydrogen from the second textile fabric and/or from the water or from the electrolyte with hydrogen enriched therein from the second textile fabric;
k) optionally separating hydrogen from the hydrogen-enriched water or from the hydrogen-enriched electrolyte;
l) optionally separating oxygen from the oxygen-enriched water or from the hydrogen-enriched electrolyte.

As already mentioned, according to the mode of operation of the electrolysis, it is possible that hydrogen or/and oxygen do not remain dissolved in water or in the basic electrolyte in the respective compartment, and the gases formed outgas of their own accord as gas bubbles. This is advantageous because the removal is then unnecessary and the desired gases are obtained directly.

As a result, it is possible to reduce electrolyser costs somewhat since fewer components are required.

A wet process with complete outgassing of hydrogen and oxygen then proceeds as follows:
a) providing at least one electrochemical cell comprising an anode, a cathode and an anion-conducting membrane disposed between anode and cathode, in which the anode is at least partly executed as a first textile fabric comprising catalytically active linear textile structures, and in which the first textile fabric is in direct contact with the membrane;
b) providing water or an aqueous electrolyte having a pH of 7 to 14;
c) providing an electrical voltage source;
d) soaking and permeating the first textile fabric with water or with the electrolyte;
e) soaking and permeating the second textile fabric with water or with the electrolyte;
f) passing water or electrolyte through the first textile fabric;
g) passing water or electrolyte through the second textile fabric;
h) contacting anode and cathode with an electrical voltage drawn from the electrical voltage source;
i) drawing off oxygen from the first textile fabric and/or from the water or from the electrolyte with oxygen enriched therein from the first textile fabric;
j) drawing off hydrogen from the second textile fabric and/or from the water or from the electrolyte with hydrogen enriched therein from the second textile fabric.

In practice, there may also be mixed forms in which both a portion of the gas formed outgases from the textile of its own accord and in which another portion remains dissolved in the water or in the electrolyte and has to be separated therefrom in a separate operation.

Unlike in the wet process variant, in the semi-dry variant, it is only either solely the anodic side (the first textile fabric, semi-dry case 1) or solely the cathodic side (the second textile fabric, semi-dry case 2) that is impregnated with water or with a basic electrolyte. The opposite compartment remains “dry”. The hydrogen gas (semi-dry case 1) or the oxygen gas (semi-dry case 2) is drawn off from the second textile fabric (cathode) or from the first (anode) textile fabric. In case 1, the oxygen accumulates in the anodic compartment filled with the water or with the basic electrolyte as in the wet variant. In case 2, the hydrogen accumulates in the cathodic compartment filled with water or with the basic electrolyte as in the wet variant.

What is advantageous in the two semi-dry variants is that there is no need for the separation from the water or from the basic electrolyte and hydrogen (case 1) or oxygen (case 2) since corresponding electrodes are not soaked with water or with the basic electrolyte and hence the gas formed contains very little water.

The basic idea of a semi-dry AEM process with water solely on the anodic side (case 1) is described in WO 2011/004343 A1.

Specifically, case 1 of the semi-dry process variant has the following steps:
a) providing at least one an electrochemical cell comprising an anode, a cathode and an anion-conducting membrane disposed between anode and cathode, in which the anode is at least partly executed as a first textile fabric comprising catalytically active linear textile structures, and in which the first textile fabric is in direct contact with the membrane;
b) providing water or an aqueous electrolyte having a pH of 7 to 14;
c) providing an electrical voltage source;
d) soaking and permeating the first textile fabric with water or with the electrolyte;
e) passing water or electrolyte through the first textile fabric;
f) contacting anode and cathode with an electrical voltage drawn from the electrical voltage source;
g) drawing off hydrogen from the second textile fabric;
h) drawing off oxygen from the first textile fabric and/or from the water or from the electrolyte with oxygen enriched therein from the first textile fabric;
i) optionally separating oxygen from the oxygen-enriched water or from the oxygen-enriched electrolyte.

In the semi-dry process (case 1), there is thus no need for the soaking of the second textile and the separation of the hydrogen from the water or from the electrolyte with hydrogen enriched therein. The hydrogen formed is directly in gaseous form in the cathodic compartment and contains very little water.

In practice, in case 1, there may also be mixed forms in which both a portion of the oxygen outgases from the first textile fabric of its own accord and in which another portion remains dissolved in the water or in the electrolyte and has to be separated therefrom in a separate operation. But if hydrogen recovery is the sole aim, it is possible to dispense with the separation of the oxygen from the water drawn off from the first textile fabric or from the electrolyte. The oxygen remains partly in the electrolyte. As a result, it is possible to reduce electrolyser costs somewhat since fewer components are required.

It is possible to dispense with separate separation of the oxygen from water or from the electrolyte when the electrolysis is run in such a way that only the cathodic side (the second textile fabric, semi-dry case 2) is soaked and permeated with water or with the basic electrolyte. The semi-dry variant in case 2 then takes the following form:
a) providing at least one electrochemical cell comprising an anode, a cathode and an anion-conducting membrane disposed between anode and cathode, in which the anode is at least partly executed as a first textile fabric comprising catalytically active linear textile structures, and in which the first textile fabric is in direct contact with the membrane;
b) providing water or an aqueous electrolyte having a pH of 7 to 14;
c) providing an electrical voltage source;
d) soaking and permeating the second textile fabric with water or with the electrolyte;
e) passing water or basic electrolyte through the second textile fabric;
f) contacting anode and cathode with an electrical voltage drawn from the electrical voltage source;
g) drawing off oxygen from the first textile fabric;
h) drawing off hydrogen from the second textile fabric and/or from the water or from the basic electrolyte with hydrogen enriched therein from the second textile fabric;
i) optionally separating hydrogen from the hydrogen-enriched water or from the hydrogen-enriched electrolyte.

In practice, in case 2 as well, there may also be mixed forms in which both a portion of the hydrogen outgases from the first textile fabric of its own accord and in which another portion remains dissolved in the water or in the basic electrolyte and has to be separated therefrom in a separate operation.

What is common to all the process variants presented here is that the porous properties of the textile fabric are utilized in order to guide fluids introduced into the cell and drawn off from the cell and gases formed, and to promote the transport thereof through the electrochemical cell. According to the invention, the textile fabric always fulfils the function of a porous transport layer and of a flow field (fluid conductor). According to the embodiment (wet, semi-dry case 1, semi-dry case 2), the fluid conducted by the textile fabric is water, liquid aqueous electrolyte, liquid electrolyte with hydrogen dissolved therein, liquid electrolyte with oxygen dissolved therein, oxygen gas or hydrogen gas. In addition, the fluid may contain multiple phases composed of the gases and liquids mentioned.

A particular advantage of the structure of the electrochemical cell presented here is that it can be used for different process variants without any need for structural alteration. Consequently, the manufacturer of the electrochemical cell needs to produce just one design of the cell, and the user of the cell is able to decide which process variant (wet, semi-dry case 1, semi-dry case 2) is the most economically viable for the application in question. In this way, the costs for the production of the cell and consequently also of the electrolyser are greatly lowered by reducing the complexity.

All the process variants presented here are preferably conducted continuously. This means that water or an aqueous basic electrolyte is supplied continuously, and gases or oxygen- and/or hydrogen-enriched water or -enriched electrolyte are drawn off continuously. The continuous supply of the water compensates for the loss of water or of the water present in the electrolyte which is caused by the electrolysis. Otherwise, the water would be consumed completely with time and electrochemical reaction would stop. Although a batch process in which the electrochemical cell is filled completely, or at least its anodic or cathodic compartment is filled, with water or with the basic electrolyte and this is electrolysed until the cell or the anodic or cathodic compartment is empty is conceivable, it is not preferred on an industrial scale.

Water electrolysis with the electrochemical cell according to the invention is preferably effected at a current density of at least 300 mA/cm² or better still at least 500 mA/cm². The cell achieves higher process intensity at these high current densities. This means that more hydrogen is produced per unit of cell area. The current density is calculated from the quotient of the current which flows between the electrodes and the effective area of the cell, i.e. the proportion of the membrane or of the electrodes which is in contact with the electrolyte.

The process according to the invention is preferably conducted in an electrolyser comprising at least two electrochemical cells according to the invention that share a common bipolar plate. This means that a bipolar plate is simultaneously in electrical contact with the anode of the first electrochemical cell of the electrolyser and with the cathode of the second electrochemical cell of the electrolyser. The two adjacent cells are then connected in series. Such an electrolyser forms a further part of the subject-matter of the invention.

The advantage of an electrolyser in which adjacent cells each share a bipolar plate is the compact stack construction thereof and hence the small construction size thereof. Preferably, the electrolyser comprises more than two adjacent cells that share a common bipolar plate. According to the size of the individual electrochemical cells and according to the power required, it is possible for up to 500 cells to be stacked to form an electrolyser via bipolar plates.

A further advantage of the electrolyser of the invention is that it can be manufactured with a high degree of automation: This is because the individual components of the electrochemical cells can be stacked very efficiently with a robot. In this way, production costs for the electrolyser are lowered further.

The invention likewise provides a process for producing an electrolyser comprising at least two electrochemical cells according to the invention that share a common bipolar plate when the following components are stacked directly one on top of another in this sequence in the course of production:

In this process procedure, stacking is from anode to cathode.
a) a first textile fabric;
b) an anion-conducting membrane, optionally provided with a catalyst layer;
c) a second textile fabric, optionally provided with a catalyst layer;
d) a bipolar plate;
e) a first textile fabric;
f) an anion-conducting membrane, optionally provided with a catalyst layer;
g) a second textile fabric, optionally provided with a catalyst layer.

It is equally possible to stack from cathode to anode. The stack sequence is then as follows:
a) a second textile fabric, optionally provided with a catalyst layer;
b) an anion-conducting membrane, optionally provided with a catalyst layer;
c) a first textile fabric;
d) a bipolar plate;
h) a second textile fabric, optionally provided with a catalyst layer;
i) an anion-conducting membrane, optionally provided with a catalyst layer;
j) a first textile fabric.

Both stack sequences lead to the same electrolyser.

In order to contact more than two adjacent cells according to the invention with one another via a common bipolar plate in accordance with the invention, it is possible to run through stack sequences repeatedly. After each run, a bipolar plate should be inserted.

For example, the stack sequence when three cells are stacked from anode in cathode direction is as follows:
a) a first textile fabric;
b) an anion-conducting membrane, optionally provided with a catalyst layer;
c) a second textile fabric, optionally provided with a catalyst layer;
d) a bipolar plate;
e) a first textile fabric;
f) an anion-conducting membrane, optionally provided with a catalyst layer;
g) a second textile fabric, optionally provided with a catalyst layer;
h) a bipolar plate;
i) a first textile fabric;
j) an anion-conducting membrane, optionally provided with a catalyst layer;
k) a second textile fabric, optionally provided with a catalyst layer.

All stacks may be provided with an end plate at either end of the stack, which is correspondingly connected in a monopolar manner.

The stacking is preferably automated, especially using a robot.

The production of the electrolyser is particularly effective when the first and second textile fabrics consist of the same material. In this case, the variety of components is smaller, which increases the speed of assembly and reduces electrolyser costs. In that case too, the stacking process is better executable with a robot because the robot does not need to distinguish between anode and cathode, but instead has to install just one kind of electrode.

The production of the electrolyser is even more effective when the first and/or second textile fabric is electrically connected and mechanically fixed to the bipolar plate prior to the assembly of the electrolyser, so as to form a component. This can be effected, for example, by the spot welding of the two textile fabrics and the bipolar plate. In this way, the variety of components becomes even smaller, which further increases the speed of assembly and reduces electrolyser costs. The spot welding can be effected with another robot or with the robot that assembles the cell thereafter.

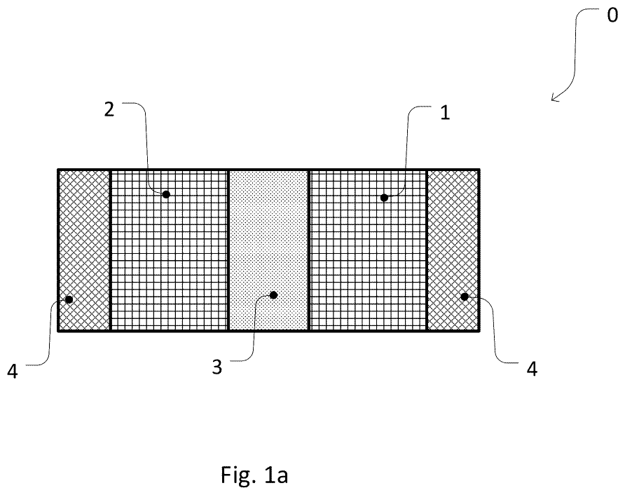

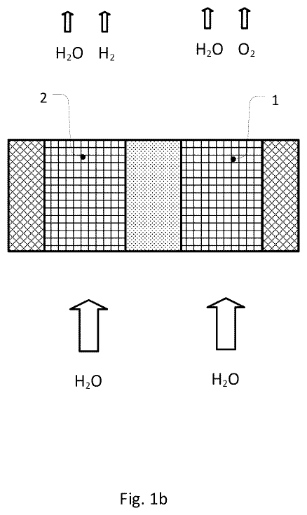

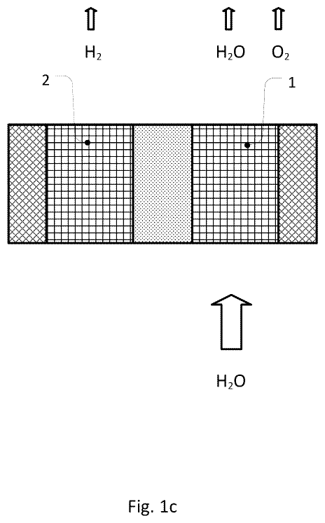

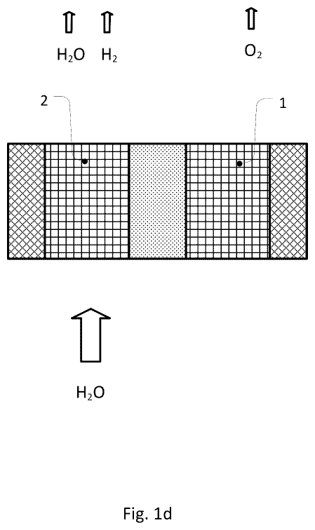

The invention will now be described by working examples. For this purpose, the figures show-FIG. 1a: schematic diagram of the design of a first embodiment of an electrochemical cell;

FIG. 1b: schematic diagram of the operation of the first embodiment of an electrochemical cell (FIG. 1a) in a wet process variant;

FIG. 1c: schematic diagram of the operation of the first embodiment of an electrochemical cell (FIG. 1a) in a semi-dry process variant (case 1-“dry cathode”);

FIG. 1d: schematic diagram of the operation of the first embodiment of an electrochemical cell (FIG. 1a) in a semi-dry process variant (case 2-“dry anode”);

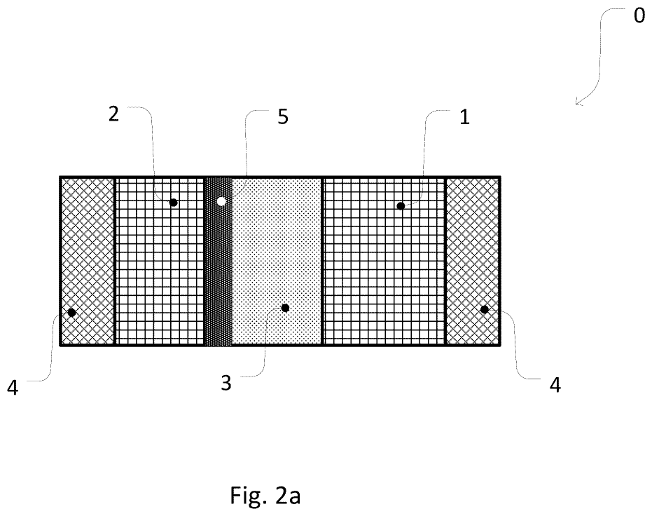

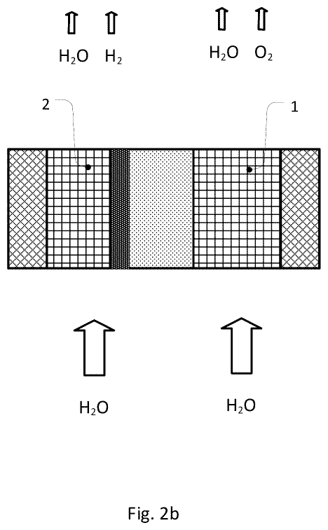

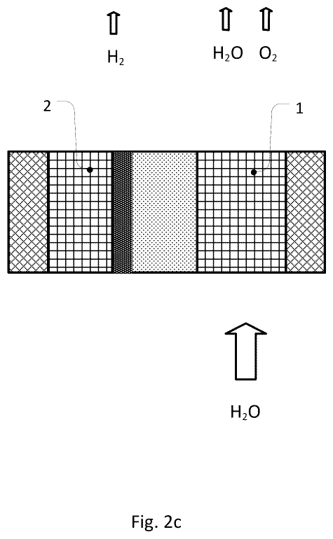

FIG. 2a: schematic diagram of the design of a second embodiment of an electrochemical cell;

FIG. 2b: schematic diagram of the operation of the second embodiment of an electrochemical cell (FIG. 2a) in a wet process variant;

FIG. 2c: schematic diagram of the operation of the second embodiment of an electrochemical cell (FIG. 2a) in a semi-dry process variant (case 1—“dry cathode”);

FIG. 2d: schematic diagram of the operation of the second embodiment of an electrochemical cell (FIG. 2a) in a semi-dry process variant (case 2—“dry anode”);

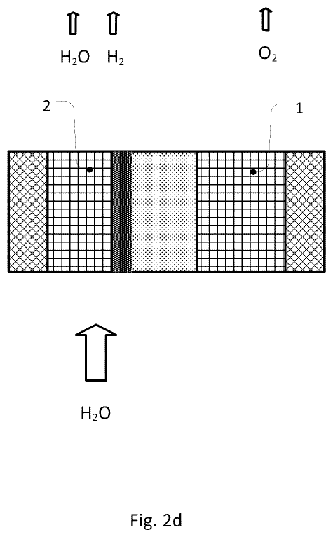

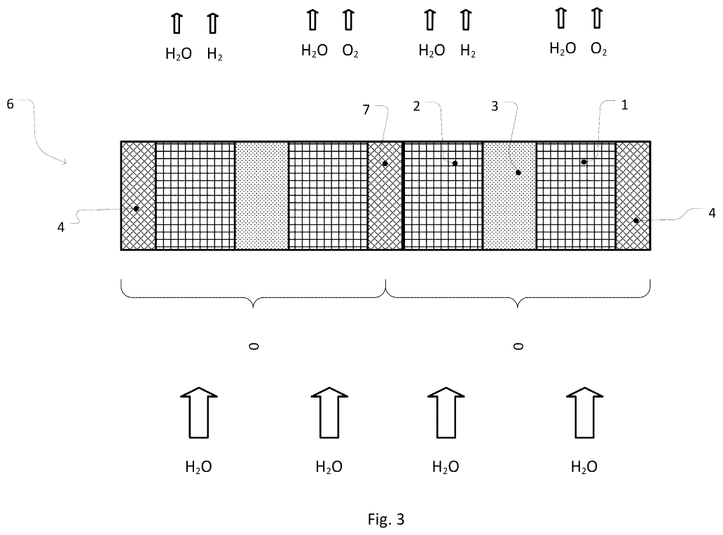

FIG. 3: schematic diagram of one operation variant of an electrolyser comprising two electrochemical cells according to the first embodiment (FIG. 1a);

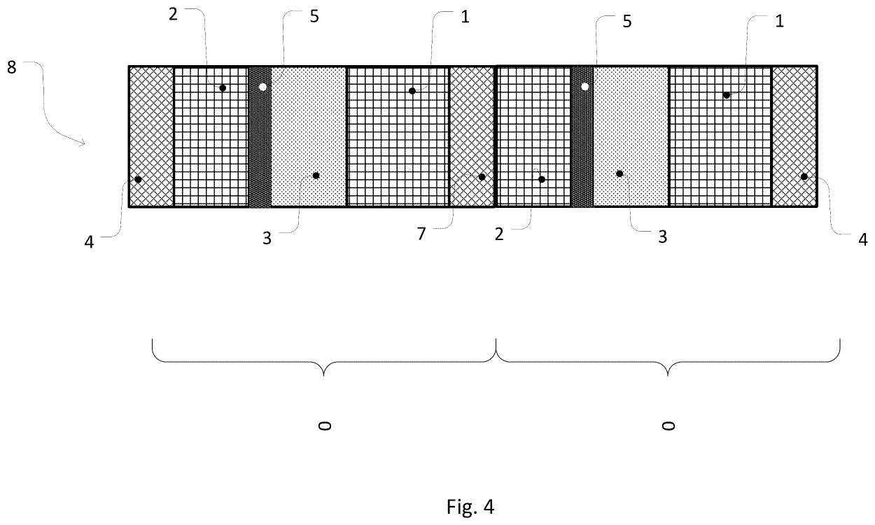

FIG. 4: schematic diagram of the design of an electrolyser comprising two electrochemical cells according to the second embodiment (FIG. 2a);

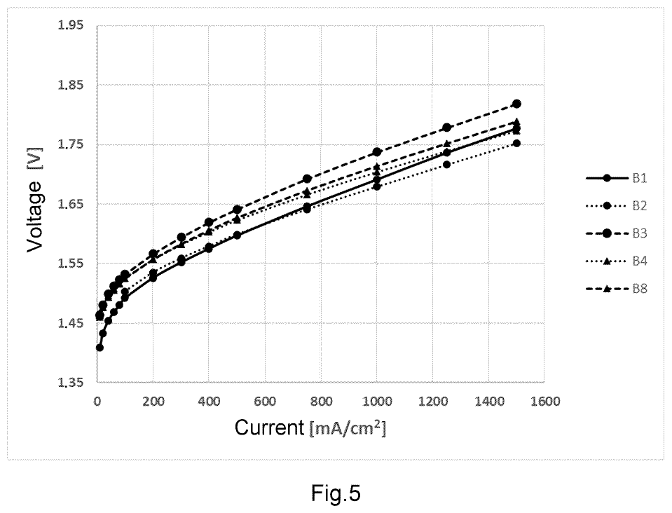

FIG. 5: Graph of the UI characteristics of Examples 1 to 4 and 8;

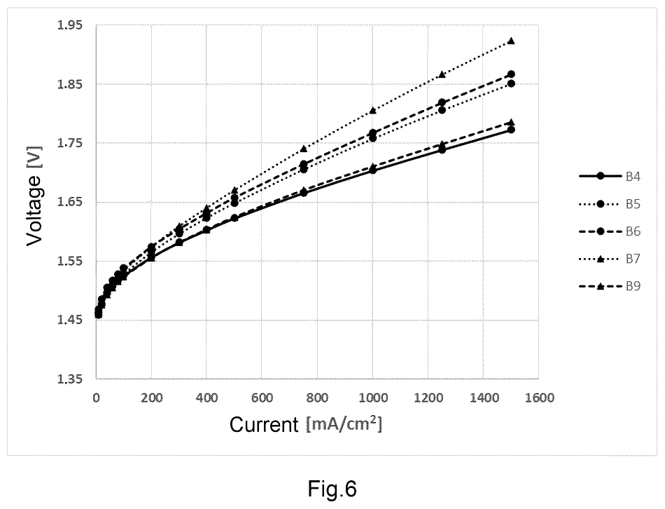

FIG. 6: Graph of the UI characteristics of Examples 4 to 7 and 9;

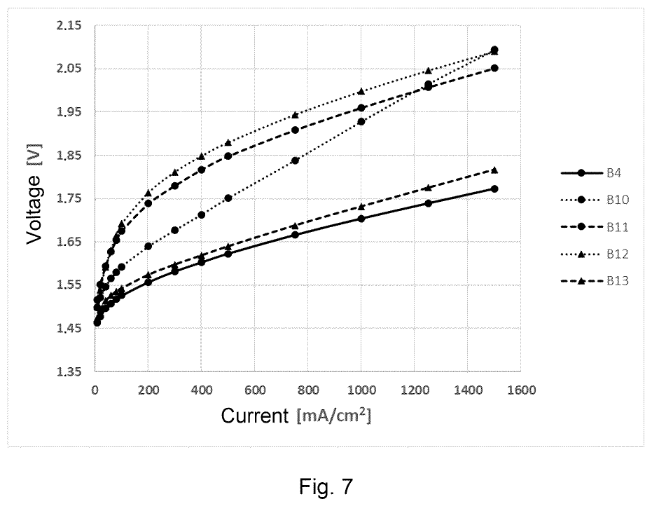

FIG. 7: Graph of the UI characteristics of Examples 4 and 10 to 13;

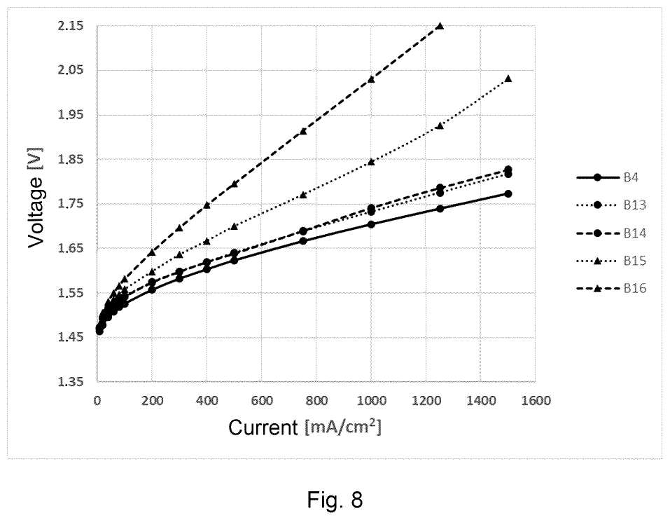

FIG. 8: Graph of the UI characteristics of Examples 4 and 13 to 16;

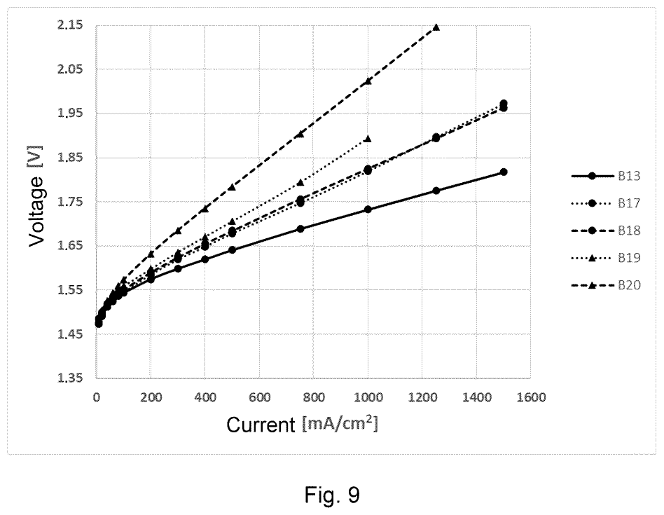

FIG. 9: Graph of the UI characteristics of Examples 13 and 17 to 20;

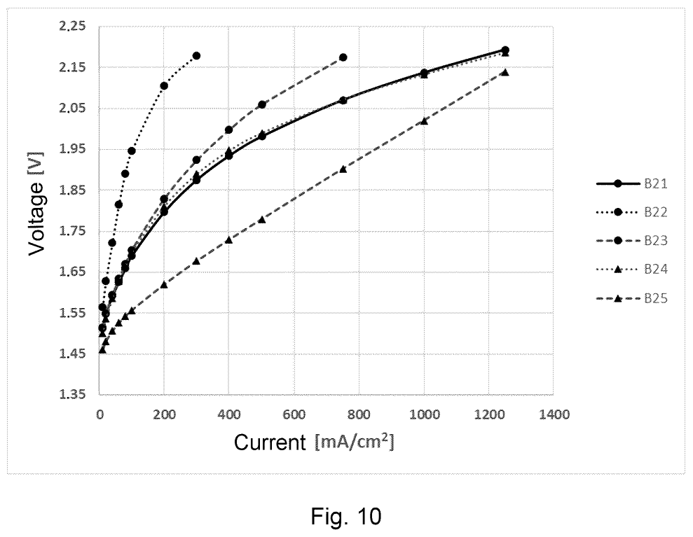

FIG. 10: Graph of the UI characteristics of Examples 21 to 25;

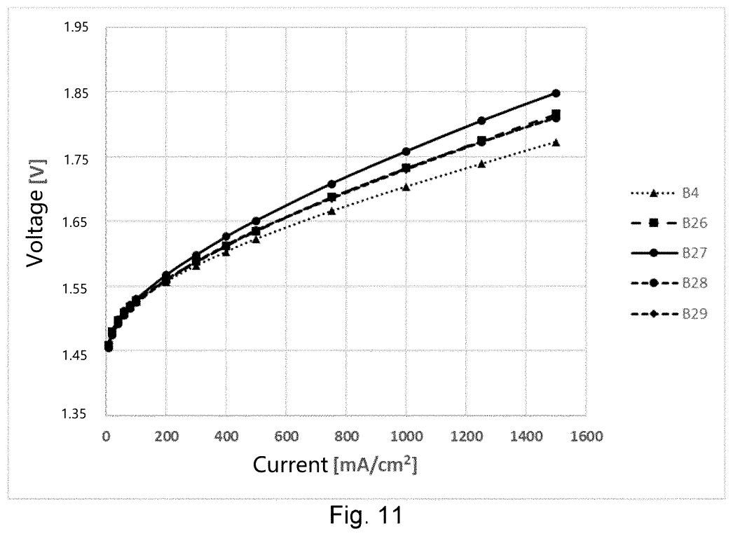

FIG. 11: Graph of the UI characteristics of Examples 4, 26 to 29.

FIG. 1a shows a schematic of a first embodiment of an electrochemical cell 0 in cross section. This comprises an anode 1, a cathode 2, and an anion-conducting membrane 3 disposed between anode 1 and cathode 2. The anode 1 and cathode 2 are each executed as a textile fabric comprising Ni-containing fibres.

The membrane 3 is a two-dimensional membrane made of an ionomer that has been produced according to example 3 of WO 2021/013694 A1. The membrane 3 was produced according to Example 4 of WO 2021/013694 A1. The anode 1 and cathode 2 each directly adjoin the membrane 3. On their side remote from the membrane 3, anode 1 and cathode 2 are each in contact with an end plate 4.

The effective area of the anode 1 and cathode 2 extends at right angles to the plane of the drawing. In particular, the electrochemical cell 0 does not have a separate flow distributor or a separate porous transport layer (PTL) or separate catalytically active catalyst layers. The function of flow distributor and PLT is assumed by the anode 1 and the cathode 2 themselves, since they consist of a textile fabric that is simultaneously fluid-conducting. The fibrous material contains nickel and iron. In the simplest case, the fibre material is stainless steel, which generally contains nickel and iron. In the operation of the cell, oxidation of nickel and iron forms a mixed Ni—Fe oxide or mixed Ni—Fe hydroxide that is catalytically active. Consequently, the fibre material provides the catalytically active material; no additional catalyst layer is needed.

The electrochemical cell 0 permits three modes of operation: wet, semi-dry case 1 and semi-dry case 2.

FIG. 1b shows a schematic of the operation of the electrochemical cell from FIG. 1a in a wet process variant. Anode 1 and cathode 2 here are soaked with water or a basic electrolyte and permeated therewith in electrolysis operation.

FIG. 1c shows a semi-dry process variant in which only the anode 1 of the electrochemical cell 0 from FIG. 1a is soaked with water or a basic electrolyte and is permeated therewith in electrolysis operation (semi-dry case 1). The cathode 2 remains dry.

FIG. 1d shows a semi-dry process variant in which only the cathode 2 of the electrochemical cell 0 from FIG. 1a is soaked with water or a basic electrolyte and is permeated therewith in electrolysis operation (semi-dry case 2). The anode 1 remains dry.

FIG. 2a shows a schematic of the design of a second embodiment of an electrochemical cell 0 in cross section. This comprises an anode 1, a cathode 2, and an anion-conducting membrane 3 disposed between anode 1 and cathode 2. The anode 1 and cathode 2 are each executed as a textile fabric comprising Ni-containing fibres. The membrane 3 is a two-dimensional membrane made of an ionomer that has been produced according to example 3 of WO 2021/013694 A1. The membrane 3 was produced according to Example 4 of WO 2021/013694 A1. The two electrodes (anode 1 and cathode 2) directly adjoin the membrane 3. On their side remote from the membrane 3, anode 1 and cathode 2 are each in contact with an end plate 4.

The second embodiment is characterized by a catalyst layer 5 disposed between the cathode 2 and membrane 3. The catalyst layer 5 may have been applied here to the cathode 2 and/or to the cathodic side of the membrane 3. The catalyst layer 5 contains catalytically active particles or catalytically active coating (electrocatalyst) fixed on the cathode 2 without an ionomer (Examples 11-12) or fixed on the cathode 2 with an ionomer (Examples 1-10) or on the membrane 3 via an ionomer (Examples 13-20). The catalytically active particles or catalytically active coating are Au—, Pt—, Rh—, Ru—, Pd—, Ag—, Ni—, Co—, Cu—, Fe—, Mn—, Mo-containing metallic particles or alloys or coating or compounds, for example sulfides, selenides, oxides, mixed oxides, hydroxides, mixed hydroxides, spinels or perovskites having a particle size or thickness of the coating of 1 nm to 10 μm. Catalytically active particles may be unsupported or supported on carbonaceous materials, for example carbon black or charcoal, or on oxides, for example CeO₂, TiO₂ or WO₃. The concentration of the active material is between 0.01 mg/cm² and 25 mg/cm², preferably between 0.05 mg/cm² and 5 mg/cm², based on the membrane or electrode area (cathode 2). The thickness of the particle-containing catalyst layer is between 1 μm and 500 μm, preferably between 5 μm and 100 μm. The ionomer is the same material from which the membrane 3 has been produced (Example 3 of WO 2021/013694 A1). The membrane 3, on account of its active catalyst layer 5, should be regarded as a “catalyst coated membrane”—CCM—and the cathode 2, on account of its active catalyst layer 5, as a “catalyst coated substrate”—CCS.

Anode 1, cathode 2 and end plates 4 in the second embodiment (FIG. 2a) are just as in the first embodiment (FIG. 1a). Here too, components 1, 2, 3 and 4 are contacted directly to one another, with the catalyst layer 5 disposed between the cathode 2 and membrane 3. This is not a contradiction, however, because the catalyst layer 5 is regarded as a constituent of the cathode 2 (CCS approach) or of the membrane 3 (CCM approach).

The electrochemical cell 0 from FIG. 2a permits three modes of operation: wet, semi-dry case 1 and semi-dry case 2.

FIG. 2b shows the wet process variant in which anode 1 and cathode 2 are soaked with water or a basic electrolyte and permeated therewith in electrolysis operation.

FIG. 2c shows the semi-dry process variant in which only the anode 1 is soaked with water or a basic electrolyte and is permeated therewith in electrolysis operation (semi-dry case 1).

FIG. 2d shows the semi-dry process variant in which only the cathode 2 is soaked with water or a basic electrolyte and is permeated therewith in electrolysis operation (semi-dry case 2).

FIG. 3 shows a schematic of a first electrolyser 6 in wet operation. The electrolyser 6 comprises two adjacent electrochemical cells 0 according to the first embodiment that are of identical construction and are contacted via a common bipolar plate 7.

For performance of water electrolysis with the first electrolyser 6, all electrodes are soaked with water or with a basic electrolyte and permeated continuously therewith in electrolysis operation. This mode of operation corresponds to the process variant described above as “wet” because all the textile fabrics are soaked and permeated with water or with a basic electrolyte. Then an electrical voltage acting between anode 1 and cathode 2 is applied to each cell. The effect of this, according to the principle described above, is water electrolysis and associated release of hydrogen (H₂) in the textile fabrics that form the cathode 2 and of oxygen (O₂) in the textile fabrics that form the anode 1. Oxygen (O₂), hydrogen (H₂) and unelectrolysed water (H₂O) or basic electrolyte are correspondingly drawn off from the anode 1 and cathode 2, and water and basic electrolyte are pumped continuously through anode 1 and cathode 2.

FIG. 4 shows a schematic of a second electrolyser 8 in operation. The second electrolyser 8 comprises two adjacent electrochemical cells 0 according to the second embodiment that are of identical construction and are contacted via a common bipolar plate 7.

For performance of water electrolysis with the second electrolyser 8, all electrodes are soaked with water or with a basic electrolyte and permeated therewith in electrolysis operation. This mode of operation corresponds to the process variant described above as “wet” because both felts are soaked with water or with a basic electrolyte. Then an electrical voltage acting between anode 1 and cathode 2 is applied to each cell. The effect of this, according to the principle described above, is water electrolysis and associated release of hydrogen (H₂) in the textile fabrics that form the cathode 2 and of oxygen (O₂) in the textile fabrics that form the anode 1. Oxygen (O₂), hydrogen (H₂) and unelectrolysed water (H₂O) or basic electrolyte are correspondingly drawn off from the anode 1 and cathode 2, and water and basic electrolyte are pumped continuously through anode 1 and cathode 2.

### EXAMPLES

All the working examples were conducted in an electrochemical cell consisting of anode 1, cathode 2, membrane 3, and two end plates 4 with active area 16 cm². This was done using two different types of end plate in each case on the cathode side and on the cathode side: type I end plate (with flow distributor in the form of elongated channels of width 1.5 mm with one feed and one drain per channel) and type II end plate (without flow distributor, with ten round feeds having Dᵢₙ=1.5 mm on one side and ten round drains having Dᵢₙ=1.5 mm on the opposite side). The membrane 3 is a two-dimensional membrane made of an ionomer that has been produced according to example 3 of WO 2021/013694 A1. The membrane 3 was produced according to Example 4 of WO 2021/013694 A1 and has a thickness of 50 μm. Membrane 3 was ion-exchanged before each experiment in 1 M KOH at 60° C. for 24 hours. The electrolyte used was 1 M KOH, which was pumped through the anode 1 and/or through the cathode 2 at 50 ml/min. All experiments were conducted at 60° C., with control solely of the electrolyte temperature. Individual special features of the respective working examples are stated separately.

The following materials were utilized:
SAE 316L stainless steel felt (2-ply (ply 1—finer 4 μm fibres, ply 2—coarser 8 μm fibres, thickness=300 μm, porosity=80%, sample name “steel felt”);
SAE 316L stainless steel felt (1-ply composed of 2 μm fibres, thickness=200 μm, porosity=80%, sample name “1L-2 μm steel felt”);
SAE 316L stainless steel felt (1-ply composed of 4 μm fibres, thickness=270 μm, porosity=80%, sample name “1L-4 μm steel felt”);
SAE 316L stainless steel felt (1-ply composed of 8 μm fibres, thickness=350 μm, porosity=80%, sample name “1L-8 μm steel felt”);
nickel felt (S80422, thickness=300 μm, porosity=80%, sample name “Ni felt”, Stanford Advanced Materials, USA);
carbon fibre web (TGP-H120, thickness=370 μm, porosity=78%, sample name “carbon fibre web”, Toray Industries Inc., JP);
Pt/C (60 wt. % Pt on carbon support, article no. AB204745, abcr GmbH, DE);
Ir (99.8% Ir, article no. 12071, Alfa Aesar GmbH & Co KG, DE).

A first test ink containing catalytically active Pt/C and a second test ink containing catalytically active Ir was produced as follows:

The basis of the production of test inks with ionomers is the production of an ionomer solution. Examples of suitable solvents are N-methyl-2-pyrrolidone (NMP), N,N-dimethylformamide (DMF), N,N-dimethylacetamide (DMAC) or dimethyl sulfoxide (DMSO), preference being given to DMSO since it is classified as a non-hazardous material. The proportion of the polymer is between 10 mg/ml and 500 mg/ml, preferably between 25 mg/ml and 200 mg/ml.

The mass ratio of ionomer to catalytically active substance is between 1:1 and 1:20 or between 1:3 and 1:5 in the case of catalysts based, for example, on platinum supported on carbon (Pt/C) or iridium (Ir).

Catalyst and ionomer solution may firstly be applied directly (for example by means of screenprinting or a knife-coating method) after dispersing (for example with an ULTRA-TURRAX4 dispersing system from IKA, Staufen, DE or a three-roll mill, for example from EXAKT, Norderstedt, DE—under the action of shear, both result in the adjustment of particle size (d₅₀ in the range between 0.1 μm and 50 μm) and dispersion. Secondly, especially for application by spraying processes, it is possible to produce aqueous dispersions in which a catalyst is first dispersed in a solution of water and lower alcohols (preferably ethanol, 1-propanal or 2-propanol) under the action of ultrasound or a disperser (for example with an ULTRA-TURRAX4 dispersing system from IKA, Staufen, DE with additional adjustment of the particle size: d₅₀ in the range between 0.1 μm and 50 μm), and to which the ionomer solution (preferably 50 mg/ml) is subsequently added with subsequent further dispersion under ultrasound. The solids concentration here is between 5 mg/ml and 100 mg/ml, preferably between 10 mg/ml and 25 mg/ml. The unit mg/ml of the ionomer solution is based on the mass of polymer/volume of solvent or of the dispersion to mass of catalyst/volume of liquid constituents.

The ionomer used in the production of the test inks is a substance produced as described in example 3 of WO 2021/013694 A1. Table 1 shows the composition of the test inks.

TABLE 1
Composition of the test inks

| | Ionomer | | | | | | |
|---|---|---|---|---|---|---|---|
| | solution | | | | | Catalytically | Solids |
| Test | Concentration | | | Dispersant | | active | content |
| ink | Ionomer in | Mass ratio | | Proportion | Proportion | substance | Concentration |
| # | DMSO [mg/ml] | Particle | Ionomer | of water | of ethanol | Designation | [mg/ml] |
| 1 | 50 | 3 | 1 | 1 | 1 | Pt/C | 11 |
| 2 | 50 | 4 | 1 | 1 | 1 | Ir | 11 |

Production of anode 1 or cathode 2 coated with the test ink (both as CCS approach) or a membrane 3 coated with test ink #1 (CCM approach) was conducted as follows:

Above-described Pt/C test ink #1 or Ir-contained test ink #2 was sprayed with a PRISM 400 ultrasound spray coater (from Ultrasonic Systems, Inc, Haverhill, MA, US) onto the selected substrates (carbon fibre web or steel felt) or, in the case of the Pt/C-contained test ink #1, also directly onto one side of membrane 3 (i.e. one-sidedly). The ink was stirred continuously during the process, and the substrates and the membrane 3 were kept at a temperature of 60° C., as a result of which the dispersant evaporated continuously, leaving the electrocatalyst as a thin solid layer on the surface of the substrate or of the membrane. The resulting loading of Pt was 0.6 mg_{Pt}/cm². The resulting loading of Ir was 1 mg_{Ir}/cm².

In the case of direct one-sided coating of the membrane 3, in the electrolysis testing, an additional porous transport layer (carbon fibre web or steel felt) was installed on the cathode side between the end plate and the single-sidedly coated membrane 3.

As an alternative to the spraying method, sputtering of a 50 nm thin Pt layer onto the surface of selected substrates (carbon fibre web or steel felt) was employed. This was done using Q150R ES PLUS sputtering equipment (Quorum Technologies Ltd., UK), and the control of the layer thickness was implemented by means of the installed layer thickness monitor.

For a better overview, the conditions and the components used in the individual working examples are summarized in Table 2.

TABLE 2
Summary of the components used in individual working examples. [C] represents cathode and [A] represents anode.
Details in the “Transport layer” column indicate whether an additional transport layer was used in the electrolysis
testing (carbon fibre web or steel felt) or not (“none”). “Substrate” indicates which material was used as
substrate for the coating with the electrocatalyst or as electrode without coating with the electrocatalyst. The electrode
type indicates whether the CCS approach (substrate was coated with the electrocatalyst) or CCM approach (membrane was coated
with the electrocatalyst) was employed. Details in the “Flow field” column indicate whether a type I end plate (with
flow distributor) or type II end plate (without flow distributor) was used. Details in the “Electrolyte” column
indicate whether a corresponding electrode was operated “WITH” (i.e. electrode was soaked and pumped through with
water or with the basic electrolyte, i.e. a wet process variant) or “WITHOUT” (i.e. electrode was not soaked or
pumped through with water or with the basic electrolyte, i.e. a semi-dry process variant) electrolyte.

| | [C] | | | [C] | | | | [A] | | |
|---|---|---|---|---|---|---|---|---|---|---|
| [C] | Transport | [C] | Electrode | Flow | [C] | [A] | [A] | Flow | [A] | |
| Catalyst | layer | Substrate | type | field | Electrolyte | Catalyst | Substrate | field | Electrolyte | Example # |
| Pt/C | none | Carbon | CCS | Type I | WITH | Ir | Steel | Type I | WITH | 1 |
| | | fibre web | | | | | felt | | | |
| Pt/C | none | Carbon | CCS | Type I | WITH | Ir | Steel | Type II | WITH | 2 |
| | | fibre web | | | | | felt | | | |
| Pt/C | none | Carbon | CCS | Type I | WITH | Pt | Steel | Type I | WITH | 3 |
| | | fibre web | | | | | felt | | | |
| Pt/C | none | Carbon | CCS | Type I | WITH | Stainless | Steel | Type I | WITH | 4 |
| | | fibre web | | | | steel | felt | | | |
| Pt/C | none | Carbon | CCS | Type I | WITHOUT | Stainless | Steel | Type I | WITH | 5 |
| | | fibre web | | | | steel | felt | | | |
| Pt/C | none | Carbon | CCS | Type I | WITH | Stainless | Steel | Type I | WITHOUT | 6 |
| | | fibre web | | | | steel | felt | | | |
| Pt/C | none | Steel | CCS | Type I | WITH | Stainless | Steel | Type I | WITH | 7 |
| | | felt | | | | steel | felt | | | |
| Pt/C | none | Carbon | CCS | Type I | WITH | Stainless | Steel | Type II | WITH | 8 |
| | | fibre web | | | | steel | felt | | | |
| Pt/C | none | Carbon | CCS | Type II | WITH | Stainless | Steel | Type I | WITH | 9 |
| | | fibre web | | | | steel | felt | | | |
| Pt/C | none | Carbon | CCS | Type I | WITH | Ni | Ni felt | Type I | WITH | 10 |
| | | fibre web | | | | | | | | |
| Pt | none | Steel | CCS | Type I | WITH | Stainless | Steel | Type I | WITH | 11 |
| | | felt | | | | steel | felt | | | |
| Pt | none | Carbon | CCS | Type I | WITH | Stainless | Steel | Type I | WITH | 12 |
| | | fibre web | | | | steel | felt | | | |
| Pt/C | Carbon | Membrane | CCM | Type I | WITH | Stainless | Steel | Type I | WITH | 13 |
| | fibre web | | | | | steel | felt | | | |
| Pt/C | Carbon | Membrane | CCM | Type I | WITHOUT | Stainless | Steel | Type I | WITH | 14 |
| | fibre web | | | | | steel | felt | | | |
| Pt/C | Carbon | Membrane | CCM | Type I | WITH | Stainless | Steel | Type I | WITHOUT | 15 |
| | fibre web | | | | | steel | felt | | | |
| Pt/C | Steel | Membrane | CCM | Type I | WITH | Stainless | Steel | Type I | WITH | 16 |
| | felt | | | | | steel | felt | | | |
| Pt/C | Carbon | Membrane | CCM | Type II | WITH | Stainless | Steel | Type I | WITH | 17 |
| | fibre web | | | | | steel | felt | | | |
| Pt/C | Carbon | Membrane | CCM | Type II | WITHOUT | Stainless | Steel | Type I | WITH | 18 |
| | fibre web | | | | | steel | felt | | | |
| Pt/C | Carbon | Membrane | CCM | Type II | WITH | Stainless | Steel | Type I | WITHOUT | 19 |
| | fibre web | | | | | steel | felt | | | |
| Pt/C | Steel | Steel | CCM | Type II | WITH | Stainless | Steel | Type I | WITH | 20 |
| | felt | felt | | | | steel | felt | | | |
| Ni | none | Ni felt | CCS | Type I | WITH | Stainless | Steel | Type I | WITH | 21 |
| | | | | | | steel | felt | | | |
| Ni | none | Ni felt | CCS | Type I | WITHOUT | Stainless | Steel | Type I | WITH | 22 |
| | | | | | | steel | felt | | | |
| Ni | none | Ni felt | CCS | Type I | WITH | Stainless | Steel | Type I | WITHOUT | 23 |
| | | | | | | steel | felt | | | |
| Ni | none | Ni felt | CCS | Type I | WITH | Stainless | Steel | Type II | WITH | 24 |
| | | | | | | steel | felt | | | |
| Ni | none | Ni felt | CCS | Type II | WITH | Stainless | Steel | Type I | WITH | 25 |
| | | | | | | steel | felt | | | |
| Pt/C | none | Carbon | CCS | Type I | WITH | Stainless | Steel | Type I | WITH | 26 |
| | | fibre web | | | | steel | felt, | | | |
| | | | | | | | 8 μm fibres | | | |
| | | | | | | | toward the | | | |
| | | | | | | | membrane | | | |
| Pt/C | none | Carbon | CCS | Type I | WITH | Stainless | 1L-2 μm | Type I | WITH | 27 |
| | | fibre web | | | | steel | steel felt | | | |
| Pt/C | none | Carbon | CCS | Type I | WITH | Stainless | 1L-4 μm | Type I | WITH | 28 |
| | | fibre web | | | | steel | steel felt | | | |
| Pt/C | none | Carbon | CCS | Type I | WITH | Stainless | 1L-8 μm | Type I | WITH | 29 |
| | | fibre web | | | | steel | steel felt | | | |

### Example 1

A cathode was produced selecting carbon fibre web as substrate. The substrate was coated with the Pt/C-containing ink, the production of which was described above, with a PRISM 400 ultrasound spray coater (from Ultrasonic Systems, Inc, Haverhill, MA, US). The resulting loading of Pt was 0.6 mg/cm².

An anode was produced selecting steel felt as substrate. The substrate (side with finer 4 μm fibres) was coated with the Ir-containing ink, the production of which was described above, with a PRISM 400 ultrasound spray coater (from Ultrasonic Systems, Inc, Haverhill, MA, US). The resulting loading of Ir was 1 mg/cm². Steel felt was incorporated with finer 4 μm fibres toward the membrane.

Type I end plates were used at both ends.

### Example 2

Analogous to Example 1, except that a type II end plate was used on the anode side.

### Example 3

The cathode utilized was an electrode as in Example 1. The anode utilized was a steel felt coated with 50 nm of Pt (side with finer 4 μm fibres) as electrocatalyst. Steel felt was incorporated with finer 4 μm fibres toward the membrane.

### Example 4

Analogous to Example 3, except that the anode utilized was an uncoated steel felt. Steel felt was incorporated with finer 4 μm fibres toward the membrane.

### Example 5

Analogous to Example 4, except that the cathode was not soaked with the electrolyte and not permeated during the electrolysis (semi-dry process variant, semi-dry case 1).

### Example 6

Analogous to Example 4, except that the anode was not soaked with the electrolyte and not permeated during the electrolysis (semi-dry process variant, semi-dry case 2).

### Example 7

A cathode was produced selecting steel felt as substrate. The substrate (side with finer 4 μm fibres) was coated with the Pt/C-containing ink, the production of which was described above, with a PRISM 400 ultrasound spray coater (from Ultrasonic Systems, Inc, Haverhill, MA, US). The resulting loading of Pt was 0.6 mg/cm². The anode utilized was an uncoated steel felt which was incorporated with finer 4 μm fibres toward the membrane.

### Example 8

Cathode analogous to Example 1. The anode utilized was an uncoated steel felt which was incorporated with finer 4 μm fibres toward the membrane. A type I end plate was used on the cathode side, and a type II end plate on the anode side.

### Example 9

Analogous to Example 8, except that a type II end plate was used on the cathode side, and a type I end plate on the anode side.

### Example 10

Cathode analogous to Example 1. The anode utilized was an uncoated Ni felt.

### Example 11

The cathode utilized was a steel felt coated with 50 nm of Pt (side with finer 4 μm fibres) as electrocatalyst. The anode utilized was an uncoated steel felt.

### Example 12

The cathode utilized was a carbon fibre web coated with 50 nm of Pt as electrocatalyst. The anode utilized was an uncoated steel felt which was incorporated with finer 4 μm fibres toward the membrane.

### Example 13

A cathode was produced by directly single-sidedly coating membrane (on the cathode side only) with the Pt/C-containing ink, the production of which was described above, with a PRISM 400 ultrasound spray coater (from Ultrasonic Systems, Inc, Haverhill, MA, US). The resulting loading of Pt was 0.6 mg/cm². The porous transport layer used on the cathode side was carbon fibre web. The anode utilized was an uncoated steel felt which was incorporated with finer 4 μm fibres toward the membrane.

### Example 14

Analogous to Example 13, except that the cathode was not soaked with the electrolyte and not pumped through during the electrolysis (semi-dry process variant, semi-dry case 1).

### Example 15

Analogous to Example 13, except that the anode was not soaked with the electrolyte and not pumped through during the electrolysis (semi-dry process variant, semi-dry case 2).

### Example 16

Analogous to Example 13, except that the porous transport layer used on the cathode side was a steel felt which was incorporated with finer 4 μm fibres toward the membrane.

### Example 17

Analogous to Example 13, except that a type II end plate was used on the cathode side.

### Example 18

Analogous to Example 17, except that the cathode was not soaked with the electrolyte and not permeated during the electrolysis (semi-dry process variant, semi-dry case 1).

### Example 19

Analogous to Example 17, except that the anode was not soaked with the electrolyte and not permeated during the electrolysis (semi-dry process variant, semi-dry case 2).

### Example 20

Analogous to Example 17, except that the porous transport layer used on the cathode side was a steel felt which was incorporated with finer 4 μm fibres toward the membrane.

### Example 21

The anode 1 utilized was an uncoated steel felt which was incorporated with finer 4 μm fibres toward the membrane. The cathode 2 utilized was an uncoated Ni felt.

### Example 22

Analogous to Example 21, except that the cathode was not soaked with the electrolyte and not pumped through during the electrolysis (semi-dry process variant, semi-dry case 1).

### Example 23

Analogous to Example 21, except that the anode was not soaked with the electrolyte and not pumped through during the electrolysis (semi-dry process variant, semi-dry case 2).

### Example 24

Analogous to Example 21, except that a type II end plate was used on the anode side.

### Example 25

Analogous to Example 21, except that a type II end plate was used on the cathode side.

### Example 26

Analogous to Example 4, except that steel felt was incorporated with coarser 8 μm fibres toward the membrane (“wrong” incorporation since finer 4 μm fibres not toward the membrane).

### Example 27

Analogous to Example 4, except that the anode incorporated was 1-ply 1L-2 μm steel felt.

### Example 28

Analogous to Example 4, except that the anode incorporated was 1-ply 1L-4 μm steel felt.

### Example 29

Analogous to Example 4, except that the anode incorporated was 1-ply 1L-8 μm steel felt.

### CONCLUSION

It is clearly apparent in FIG. 11 that, in the case of higher current densities over and above 300 mA/cm², in the case of “wrong” incorporation of steel felt and in the case of use of 1-ply steel felts composed of 2 μm, 4 μm and 8 μm steel fibres, a higher cell voltage is required to achieve the same current density. This means that the electrical power consumed by the cell is greater. Consequently, the energy demand in the case of a process with a single-ply or wrongly incorporated felt is greater than in the case of a two-ply felt where the finer fibres are arranged in the direction of the membrane. Accordingly, energy costs are higher per unit of hydrogen produced.

It is also apparent in FIG. 11 that the benefit of the correctly incorporated multi-ply felt is even more apparent at higher current densities exceeding 500 mA/cm². Therefore, the energy saving achievable by the correct use of the multi-ply felt is particularly large when the electrolyser is run with high process intensity.

### LIST OF REFERENCE SYMBOLS

0 electrochemical cell
1 first textile fabric (anode)
2 second textile fabric (cathode)
3 anion-conducting membrane
4 end plate
5 catalyst layer
6 electrolyser containing two adjacent electrochemical cells 0 contacted via a common bipolar plate 7, according to the first embodiment
7 bipolar plate
8 electrolyser containing two adjacent electrochemical cells 0 contacted via a common bipolar plate 7, according to the second embodiment
H₂O water or a basic electrolyte
H₂ hydrogen
O₂ oxygen

1. An electrochemical cell comprising an anode, a cathode and an anion-conducting membrane disposed between anode and cathode, where the anode is at least partly executed as a first textile fabric comprising catalytically active linear textile structures, and in that the first textile fabric is in direct contact with the membrane, where the first textile fabric and is a felt or nonwoven, characterized in that the felt or nonwoven comprises at least two types of catalytically active linear textile structure, where one type has a higher catalytic activity than the other type, and in that the type of catalytically active linear textile structure having higher catalytic activity is concentrated in a region of the textile fabric more closely adjoining the membrane than a region of the textile fabric in which the type of catalytically active linear textile structure having lower catalytic activity is concentrated.

2. The electrochemical cell according to claim 1, wherein the catalytically active linear textile structures consist of a nickel-containing material.

3. The electrochemical cell according to claim 2, wherein the nickel-containing material is selected from the group consisting of the following materials: nickel, nickel-containing alloys, especially Hastelloy, Chronin, Monel, Inconel, Incoloy, Invar, Kovar; steel containing nickel, stainless steel containing nickel, steel of steel types AISI 301, AISI 301L, AISI 302, AISI 304, AISI 304L, AISI 310, AIS1310L, AIS1316, AISI 316L, AISI 317, AISI 317L, AISI 321.

4. The electrochemical cell according to claim 1, wherein the catalytically active linear textile structures comprise a substrate provided with a catalytically active coating, where the catalytically active coating contains at least one element selected from the group consisting of Au, Pt, Ir, Rh, Ru, Pd, Ag, Ni, Co, Cu, Fe, Mn, Mo, or a compound, especially an oxide, mixed oxide, hydroxide, mixed hydroxide, spinel or perovskite, of the selected element.

5. The electrochemical cell according to claim 4, wherein the catalytically active coating is free of polymers, especially free of an ion-conducting polymer.

6. The electrochemical cell according to claim 4, wherein the substrate material is selected from the group consisting of the following materials: nickel, nickel-containing alloys, especially Hastelloy, Chronin, Monel, Inconel, Incoloy, Invar, Kovar; steel containing nickel, stainless steel containing nickel, steel of steel types AISI 301, AISI 301L, AISI 302, AISI 304, AISI 304L, AISI 310, AIS1310L, AIS1316, AISI 316L, AISI 317, AISI 317L, AISI 321; titanium, carbon.

7. The electrochemical cell according to claim 1, wherein the cathode is at least partly executed as a second textile fabric.

8. The electrochemical cell according to claim 7, wherein the second textile fabric comprises catalytically active linear textile structures.

9. The electrochemical cell according to claim 8, wherein the second textile fabric is in direct contact with the membrane.

10. The electrochemical cell according to claim 7, wherein a catalyst layer is disposed between the second textile fabric and the membrane.

11. The electrochemical cell according to claim 1, wherein the second textile fabric is a felt or nonwoven.

12. The electrochemical cell according to claim 1, wherein the felt or nonwoven is formed from at least two felt or nonwoven layers, where the fibres and/or filaments of the first layer differ with regard to their diameter from the fibres and/or filaments of the second layer, and where the layer having finer fibres and/or filaments is disposed closer to the membrane than the layer having coarser fibres and/or filaments.

13. The electrochemical cell according to claim 10, wherein the catalyst layer contains catalytically active particles and/or catalytically active coating, where the catalytically active particles and/or catalytically active coating contain(s) elements selected from the group consisting of the following elements: Au, Pt, Ru, Rh, Pd, Ag, C, S, Se, Ni, Mo, Mn, Co, Cu, Fe or compounds of the selected elements.

14. The electrochemical cell according to claim 13, wherein the catalytically active particles are embedded in an anion-conducting polymer.

15. The electrochemical cell according to claim 14, wherein the anion-conducting polymer is likewise present in the membrane.

16. The electrochemical cell according to claim 1, wherein the first textile fabric and/or the second textile fabric is at least electrically contacted, preferably electrically and mechanically contacted, with a bipolar plate on its side remote from the membrane.

17. The electrochemical cell according to claim 16, wherein the bipolar plate consists of a material selected from the group consisting of the following materials: nickel; nickel-containing alloys, especially Hastelloy, Chronin, Monel, Inconel, Incoloy, Invar, Kovar; steel containing nickel, stainless steel containing nickel, steel of steel types AISI 301, AISI 301L, AISI 302, AISI 304, AISI 304L, AISI 310, AIS1310L, AIS1316, AISI 316L, AISI 317, AISI 317L, AISI 321; nickel-plated steel, nickel-plated stainless steel, nickel-plated titanium, nickel-plated brass, carbon.

18. The process for producing hydrogen and oxygen by electrochemical splitting of water, having the following steps:
providing at least one electrochemical cell according to claim 1;
providing water or an aqueous electrolyte having a pH of 7 to 14;
providing an electrical voltage source;
soaking and permeating at least one textile fabric with water or aqueous electrolyte;
contacting anode and cathode with an electrical voltage drawn from the electrical voltage source;
drawing off oxygen from the first textile fabric;
drawing off hydrogen from the second textile fabric.

19. The process according to claim 18, having the following steps:
a) passing water or electrolyte through the first textile fabric;
b) passing water or electrolyte through the second textile fabric;
c) drawing off water or electrolyte enriched with oxygen and/or gaseous oxygen from the first textile fabric;
d) drawing off water or electrolyte enriched with hydrogen and/or gaseous hydrogen from the second textile fabric;
e) optionally separating hydrogen from the hydrogen-enriched water or from the hydrogen-enriched electrolyte;
f) optionally separating oxygen from the oxygen-enriched water or from the oxygen-enriched electrolyte.

20. The process according to claim 18, having the following steps:
a) passing water or electrolyte through the first textile fabric;
b) drawing off gaseous hydrogen from the second textile fabric;
c) drawing off water or electrolyte enriched with oxygen and/or gaseous oxygen from the first textile fabric;
d) optionally separating oxygen from the oxygen-enriched water or from the oxygen-enriched electrolyte.

21. The process according to claim 18, having the following steps:
a) passing water or electrolyte through the second textile fabric;
b) drawing off gaseous oxygen from the first textile fabric;
c) drawing off water or electrolyte enriched with hydrogen and/or gaseous hydrogen from the second textile fabric;
d) optionally separating hydrogen from the hydrogen-enriched water or from the hydrogen-enriched electrolyte.

22. An electrolyser comprising at least two electrochemical cells according to claim 16 that share a common bipolar plate.

23. A process for producing an electrolyser according to claim 22, in the course of which the following components are stacked directly one on top of another in this sequence:
a) a first textile fabric;
b) an anion-conducting membrane, optionally provided with a catalyst layer;
c) a second textile fabric, optionally provided with a catalyst layer;
d) a bipolar plate;
e) a first textile fabric;
f) an anion-conducting membrane, optionally provided with a catalyst layer;
g) a second textile fabric, optionally provided with a catalyst layer.

24. A process for producing an electrolyser according to claim 22, in the course of which the following components are stacked directly one on top of another in this sequence:
a) a second textile fabric, optionally provided with a catalyst layer;
b) an anion-conducting membrane, optionally provided with a catalyst layer;
c) a first textile fabric;
d) a bipolar plate;
e) a second textile fabric, optionally provided with a catalyst layer;
f) an anion-conducting membrane, optionally provided with a catalyst layer;
g) a first textile fabric.

25. A process for producing an electrolyser according to claim 22, in which the assembly of the electrolyser is preceded by electrical connection and mechanical fixing of the first and/or second textile fabric to the bipolar plate, especially by spot welding.

26. A process according to claim 18, performed at a current density of at least 300 mA/cm² or 500 mA/cm².
